(19) United States
(12) Patent Application Publication
(10) Pub. No.: US 2025/0262525 A1
(43) Pub. Date: Aug. 21, 2025

(54) PRIZE ACQUISITION GAME DEVICE AND CRANE

(71) Applicant: SEGA CORPORATION, Tokyo (JP)

(72) Inventor: Asako Tominaga, Tokyo (JP)

(73) Assignee: SEGA CORPORATION, Tokyo (JP)

(21) Appl. No.: 19/201,420

(22) Filed: May 7, 2025

Related U.S. Application Data
(63) Continuation of application No. PCT/JP2023/038058, filed on Oct. 20, 2023.

(30) Foreign Application Priority Data
Nov. 28, 2022 (JP) 2022-188859

(51) Int. Cl. A63F 9/30

(52) U.S. Cl. CPC A63F 9/30

(57) ABSTRACT

A prize acquisition game device includes: a housing having a housing space in which a prize is disposed; a crane configured to acquire the prize; and a crane driver that drives the crane to move in a horizontal and vertical direction in the housing space. The crane includes: a base; at least three arms that extend radially around a central axis along a vertical direction of the base; an arm connector that is disposed for each of the arms and connects each of the arms to the base; and arm drivers that are disposed respectively for the arms around the center axis and drive the arms to be opened and closed. Among the arm drivers, an arm driver that drives one of two adjacent arms is disposed to extend above the arm connector that connects another of the two adjacent arms to the base.

### BACKGROUND

### Technical Field

The present invention relates to a prize acquisition game device and a crane.

### Description of Related Art

There are known prize acquisition game devices provided with an acquisition unit (or crane) for acquiring a prize by opening and closing two arms (for example, patent document 1).

### Patent Documents

Patent Document 1: JP 2012-45204 A

### Technological Problem to be Solved by Invention

In such a prize acquisition game device, in order to enable stable acquisition of the prize, the number of arms of the acquisition unit may be increased to three or more. In this case, as the number of arms increases, the number of arm drivers that open and close the arms also increases, and thus there is a risk that the entire acquisition unit will become larger unless a large number of arm drivers are stored compactly inside the body.

### SUMMARY

One or more embodiments of the present invention reduce a size of an acquisition unit for acquiring a prize using three or more arms.

In one aspect of the present invention, a prize acquisition game device comprises: a housing having a housing space in which a prize is disposed; a crane configured to acquire the prize; and a crane driver that drives the crane to move in a horizontal and vertical direction in the housing space, wherein the crane comprises: a base; at least three arms that extend radially around a center axis along a vertical direction of the base; an arm connector that is disposed for each of the arms and connects each of the arms to the base; and arm drivers that are disposed respectively for the arms around the center axis and drive the arms to be opened and closed, wherein among the arm drivers, an arm driver that drives one of two adjacent arms is disposed to extend above the arm connector that connects another of the two adjacent arms to the base.

Other features of the present invention will become apparent from the following detailed description of the present invention and the accompanying drawings.

### BRIEF DESCRIPTION OF DRAWINGS

FIG. 1 is an external view illustrating a configuration of a prize acquisition game device 1 according to one or more embodiments.

FIG. 2 is a block diagram illustrating a configuration of a prize acquisition game device 1 according to one or more embodiments.

FIG. 3 is a schematic diagram illustrating a configuration of a moving unit (or crane driver) 50 according to one or more embodiments.

FIG. 4 is a perspective view illustrating a configuration of an acquisition unit (or crane) 130 of the comparative example.

FIG. 5 is a front view illustrating a configuration of the acquisition unit 130 of the comparative example.

FIG. 6 is a plan view illustrating a configuration of the acquisition unit 130 of the comparative example.

FIG. 7 is a perspective view illustrating a configuration of an acquisition unit 20 (or crane) according to one or more embodiments.

FIG. 8 is a front view illustrating a configuration of the acquisition unit 20 according to one or more embodiments.

FIG. 9 is a plan view illustrating a configuration of the acquisition unit 20 according to one or more embodiments.

FIG. 10 is a schematic view for describing the relationship between the arm 29, the arm coupling portion 28, and an arm driver 35 according to one or more embodiments.

FIG. 11 is a schematic view illustrating the arm 29 in a closed state according to one or more embodiments.

### DETAILED DESCRIPTION OF EMBODIMENTS

At least the following will become apparent from the description of this specification and the accompanying drawings.

That is, a prize acquisition game device comprises: a housing having a housing space in which a prize is disposed; a crane configured to acquire the prize; and a crane driver that drives the crane to move in a horizontal and vertical direction in the housing space, wherein the crane comprises: a base; at least three arms that extend radially around a center axis along a vertical direction of the base; an arm connector that is disposed for each of the arms and connects each of the arms to the base; and arm drivers that are disposed respectively for the arms around the center axis and drive the arms to be opened and closed, wherein among the arm drivers, an arm driver that drives one of two adjacent arms is disposed to extend above the arm connector that connects another of the two adjacent arms to the base.

According to such a prize acquisition game device, by effectively utilizing an upper space of the arm connectors corresponding to the respective arms, the arm drivers corresponding to the respective arms can be stored compactly inside the body, and thus the crane for acquiring the prize can be downsized using three or more arms.

Furthermore, such a prize acquisition game device may also dispose the arm drivers that drives the one of the two adjacent arms above an arm connector that connects the other of the two adjacent arms to the base by mounting the arm driver that drives the one of the two adjacent arms to the base by tilting the arm driver that drives the one of the two adjacent arms to a side of the other of the two adjacent arms.

According to such a prize acquisition game device, by attaching the arm driver that drives the one of the two adjacent arms to the base at an angle tilted to a side of the other of the two adjacent arms, the height of the arm driver in the vertical direction can be disposed while being lowered compared to the case where the arm driver is attached to the base without tilting, and thus each arm driver can be stored compactly inside the body.

Furthermore, a prize acquisition game device comprises: a housing having a housing space in which a prize is disposed; a crane configured to acquire the prize; and a crane driver that drives the crane to move in a horizontal and vertical direction in the housing space, wherein the crane comprises: a base; three arms that extend radially around a center axis along a vertical direction of the base; an arm connector that is disposed for each of the arms and connects each of the arms to the base; and arm drivers that are disposed respectively for the arms around the center axis and drive the arms to be opened and closed, wherein the arms include a first arm, a second arm, and a third arm, and the arm drivers includes: a first arm driver that drives the second arm and is disposed to extend above the arm connector that connects the first arm to the base; a second arm driver that drives the third arm and is disposed to extend above the arm connector that connects the second arm to the base; and a third arm driver that drives the first arm and is disposed to extend above the arm connector that connects the third arm to the base.

According to such a prize acquisition game device, the arm driver corresponding to the second arm can be stored compactly inside the body by effectively utilizing an upper space of the arm connector corresponding to the first arm, the arm driver corresponding to the third arm can be stored compactly inside the body by effectively utilizing an upper space of the arm connector corresponding to the second arm, and the arm driver corresponding to the first arm can be stored compactly inside the body by effectively utilizing an upper space of the arm connector corresponding to the third arm. As a result, the arm driver corresponding to each arm can be stored inside the body in a compact manner that fits well in a trifurcated shape, and thus the crane for acquiring the prize can be made smaller using the three arms.

Furthermore, such a prize acquisition game device may comprise: the first arm driver disposed to extend above the arm connector that connects the first arm to the base by tilting the first arm driver to a side of the first arm when attaching the first arm driver to the base; the second arm driver disposed to extend above the arm connector that connects the second arm to the base by tilting the second arm driver to a side of the second arm when attaching the second arm driver to the base; and the third arm driver disposed to extend above the arm connector that connects the third arm to the base by tilting the third arm driver to a side of the third arm when attaching the third arm driver to the base.

According to such a prize acquisition game device, by attaching the arm driver corresponding to each arm to the base at a tilted angle, the height of the arm driver in the vertical direction can be kept low and disposed compared to the case where the arm driver is attached to the base without tilting, and thus each arm driver can be stored compactly inside the body.

Furthermore, a crane used in a prize acquisition game device to perform a prize acquisition operation, the crane comprising: a base; at least three arms that extend radially around a center axis along a vertical direction of the base; an arm connector that is disposed for each of the arms and connects each of the arms to the base; and arm drivers that are disposed respectively for the arms around the center axis and drive the arms to be opened and closed, wherein among the arm drivers, an arm driver that drives one of two adjacent arms is disposed to extend above the arm connector that connects another of the two adjacent arms to the base.

According to such a crane, by effectively utilizing an upper space of the arm connectors corresponding to the respective arms, the arm drivers corresponding to the respective arms can be stored compactly inside the body, and thus the crane for acquiring the prize can be downsized using three or more arms.

Furthermore, a crane used in a prize acquisition game device, the crane comprising: a base; three arms that extend radially around a center axis along a vertical direction of the base; an arm connector that is disposed for each of the arms and connects each of the arms to the base; and arm drivers that are disposed respectively for the arms around the center axis and drive the arms to be opened and closed, wherein the arms include a first arm, a second arm, and a third arm, and the arm drivers include: a first arm driver that drives the second arm and is disposed to extend above the arm connector that connects the first arm to the base; a second arm driver that drives the third arm and is disposed to extend above the arm connector that connects the second arm to the base; and a third arm driver that drives the first arm and is disposed to extend above the arm connector that connects the third arm to the base.

According to such a crane, the arm driver corresponding to each arm can be stored inside the body in a compact manner that fits well in a trifurcated shape, and thus the crane for acquiring the prize can be made smaller using the three arms.

### EMBODIMENTS

### Configuration of Prize Acquisition Game Device 1

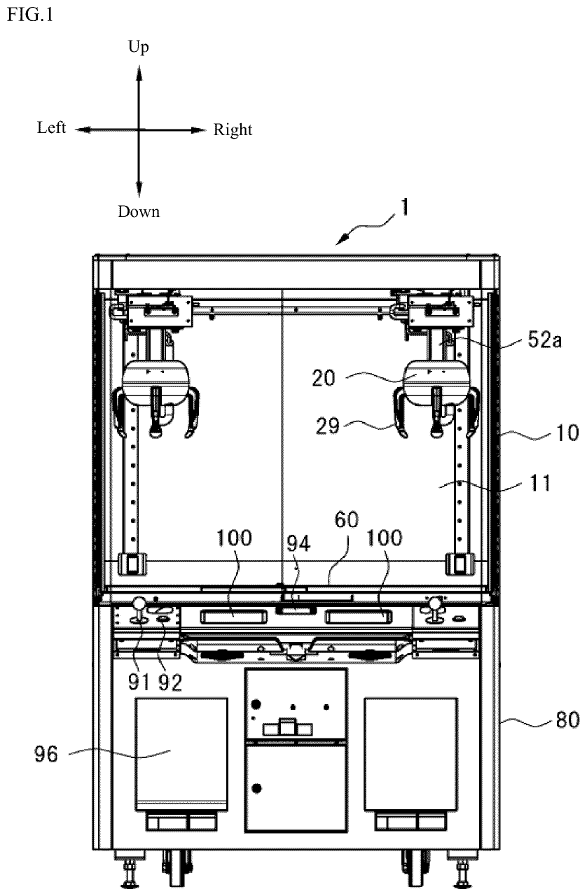

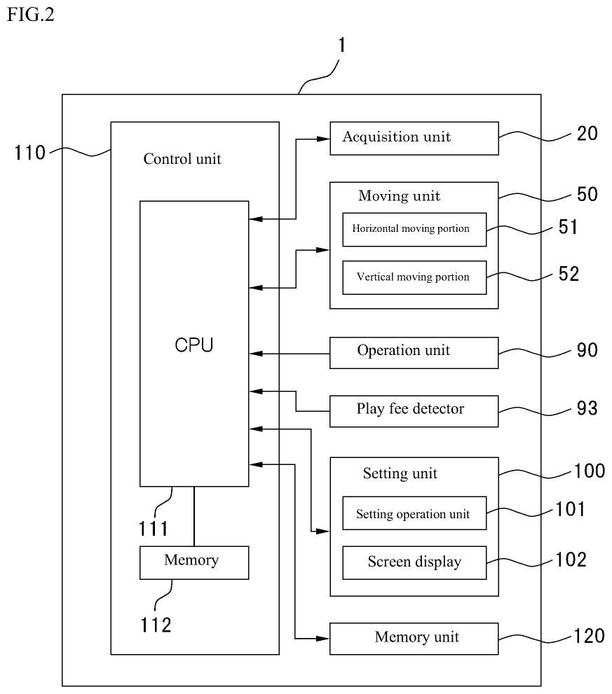

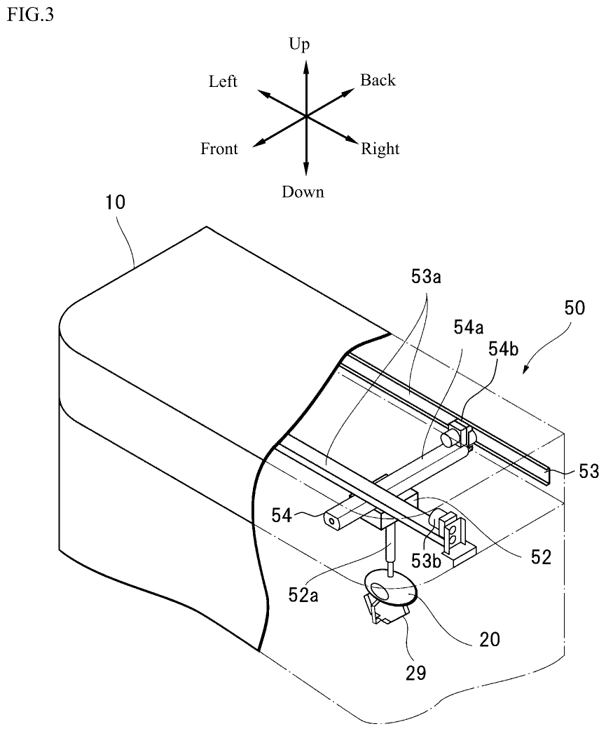

A configuration example of the prize acquisition game device 1 according to one or more embodiments will be described using FIG. 1 to FIG. 3. FIG. 1 is an external view illustrating a configuration of a prize acquisition game device 1 according to one or more embodiments. FIG. 2 is a block diagram illustrating a configuration of a prize acquisition game device 1 according to one or more embodiments. FIG. 3 is a schematic diagram illustrating a configuration of a moving unit (or crane driver) 50 according to one or more embodiments.

In the following description, each direction is defined as illustrated in each FIG. That is, the vertical direction is defined as the “up-down direction,” and “up” and “down” are defined according to gravity. In addition, the front-back directions are defined as the “front” being the front side and the “back” being the back side from the perspective of a player facing the prize acquisition game device 1. Additionally, the direction perpendicular to the up-down and front-back directions is defined as the “left-right direction,” and “right” and “left” are defined based on the view from the player's side.

The prize acquisition game device 1 of one or more embodiments is used when a player plays a prize acquisition game, and is equipped with a housing portion (or housing) 10 that stores one or more prizes, and a base portion (or base) 80 disposed below the housing portion 10.

As illustrated in FIG. 1, the housing portion 10 is formed of transparent members (for example, transparent resin, glass, or the like) on the front surface and the left-right sides so that the prize housed within the housing space can be seen by the player. An opening and closing door 11 is disposed on the front of the housing portion 10, allowing a service provider (for example, a store clerk or the like) to display and replenish the prizes.

The housing space enclosed by the housing portion 10 is used as a play field where a player plays the prize acquisition game.

As illustrated in FIG. 1 and FIG. 2, the housing portion 10 in one or more embodiments has an acquisition unit (or crane) 20 that performs the operation of acquiring or catching prizes, a moving unit 50 that moves the acquisition unit 20, and a display section (or exhibition part) 60 for displaying/exhibiting the prizes in the housing space.

Note that in one or more embodiments, as illustrated in FIG. 1, an acquisition unit 20 is disposed corresponding to each play area in which the playfield is divided left-right, and each acquisition unit 20 is configured to be able to move within each play area.

The acquisition unit 20 is a crane for acquiring the prizes contained in the housing portion 10 (the prizes displayed in the display section 60) by opening and closing the arm. As illustrated in FIG. 1, the acquisition unit 20 in one or more embodiments is configured so as to be able to grasp a prize by means of three arms, and is linked to the lower end of the lifting member 52a.

The moving unit 50 moves the acquisition unit 20 within the play field formed by the housing portion 10. As illustrated in FIG. 2, the moving unit 50 in one or more embodiments has a horizontal moving portion (or horizontal crane driver) 51 and a vertical moving portion (or vertical crane driver) 52.

The horizontal moving portion 51 moves the acquisition unit 20 horizontally (that is, front-back and left-right) on the play field. As illustrated in FIG. 3, the horizontal moving portion 51 in one or more embodiments has a left-right moving portion (left-right crane driver) 53 and a front-back moving portion (front-back crane driver) 54.

The left-right moving portion 53 moves the acquisition unit 20 left and right on the play field.

As illustrated in FIG. 3, the left-right moving portion 53 in one or more embodiments has a pair of fixed rails 53a extending in the left-right direction, a left-right moving motor 53b, an encoder that is not illustrated, and a limit sensor that is not illustrated.

The pair of fixed rails 53a are fixed to the upper portion of the housing portion 10 so as to be parallel to each other along the left-right direction. A front-back moving portion 54 is attached to the pair of fixed rails 53a so as to be slidable in the left-right direction. By driving the left-right moving motor 53b, the front-back moving portion 54 can be moved left-right along the fixed rail 53a.

The encoder detects the number of rotations of the left-right moving motor 53b. Based on the output of this encoder, the position of the front-back moving portion 54 in the left-right direction (in other words, the position of the acquisition unit 20 in the left-right direction) can be detected.

The limit sensor is for detecting when the front-back moving portions 54 reach a limit position in the left-right direction (that is, when the acquisition unit 20 reaches a limit position in the left-right direction).

The front-back moving portions 54 move the acquisition unit 20 in the front-back direction in the playfield.

As illustrated in FIG. 3, the front-back moving portions 54 in one or more embodiments include a movable rail 54a extending along the front-back directions, a front-back moving motor 54b, an encoder that is not illustrated, and a limit sensor that is not illustrated.

A vertical moving portion 52 is attached to the movable rail 54a so as to be slidable along the front-back direction. The vertical moving portion 52 can be moved in the front-back direction along the movable rail 54a by driving the front-back moving motor 54b.

The encoder detects the number of rotations of the front-back moving motor 54b. The position of the vertical moving portion 52 in the front-back direction (that is, the position of the acquisition unit 20 in the front-back direction) can be detected based on the output of this encoder.

The limit sensor is for detecting when the vertical moving portion 52 reaches a limit position in the front-back direction (that is, when the acquisition unit 20 reaches a limit position in the front-back direction).

The vertical moving portion 52 moves the acquisition unit 20 in the vertical direction (that is, the up-down direction) on the play field.

As illustrated in FIG. 3, the vertical moving portion 52 in one or more embodiments has a lifting member 52a that is configured to be freely expandable and contractable in the up-down direction, a wire winding unit that is not illustrated, a vertical moving motor that is not illustrated, an upper limit sensor that is not illustrated, and a lower limit sensor that is not illustrated.

The lifting member 52a is configured by fitting a plurality of pipes of successively smaller diameters in a telescopic manner so as to be freely slidable. The acquisition unit 20 is attached to the lower end of the lifting member 52a in a state of being connected to a wire that passes through the inside of the pipe.

The wire winding unit is driven by an up-down moving motor to wind up the wire, thereby raising the acquisition unit 20 while sequentially storing the lower pipes in the upper pipe, or to unwind the wire, thereby lowering the acquisition unit 20 while sequentially sending out the lower pipes from the upper pipe.

The upper limit sensor detects whether or not the rising of the acquisition unit 20 has stopped by winding up the wire connected to the acquisition unit 20.

The lower limit sensor detects whether the lowering of the acquisition unit 20 has stopped based on the change in the tension of the wire connected to the acquisition unit 20.

The display section 60 is for displaying the prizes in the housing portion 10, and forms the bottom surface of the play field as illustrated in FIG. 1. The display section 60 in one or more embodiments is composed of an unillustrated frame and a panel.

The frame is supported inside the base portion 80 and is configured to be able to support a plurality of panels. The panel is configured so that the prize can be displayed on the upper surface thereof, and is removable and supported with respect to the frame.

Furthermore, the disposition area where the panels are disposed becomes a display area where the prize can be displayed, while the disposition area where the panels are not disposed becomes an opening area where the prize can be passed.

When the prize that is acquired and then dropped by the acquisition unit 20 passes (drops) through the opening area of the display section 60, it is considered to have moved from the play field to the base portion 80. The prize dropped from the opening area of the display section 60 is detected by an optical sensor and then guided to the prize outlet 96 via a guide path. The optical sensor detects the presence or absence of a prize by using a light-emitting element and a light-receiving element that are installed on the guide path.

The base portion 80 is a base portion of a housing disposed below the housing portion 10, and holds the housing portion 10 at a high position so that a player can play a game while facing the front in a standing position.

As illustrated in FIG. 1 and FIG. 2, the base portion 80 in one or more embodiments has an operation unit (or input device/interface) 90, a play fee detector 93, a prize outlet 96, a setting unit 100 (or I/O interface), a control unit (or controller) 110, and a memory unit (or memory) 120.

The operation unit 90 allows the player to operate the game. As illustrated in FIG. 1 and FIG. 2, the operation unit 90 in one or more embodiments has at least a joystick 91 and an operation button 92.

The joystick 91 is an operating lever that is used by the player to move the acquisition unit 20 in the horizontal direction. The operation button 92 is an operation button used by the player to determine the position of the acquisition unit 20 in the horizontal direction. When the operation button 92 is pressed by the player, the acquisition unit 20 starts to descend at the determined position.

The play fee detector 93 detects the payment of a play fee by a player. The play fee detector 93 in one or more embodiments has a coin slot 94, a coin detection sensor that is not illustrated, a coin passage path that is not illustrated, and a coin box that is not illustrated.

In one or more embodiments, the prize acquisition game is started when a player inserts a predetermined number of coins into the coin slot 94. A coin inserted through the coin slot 94 is detected by a coin detection sensor.

The coin detection sensor is, for example, an optical sensor, and detects the presence or absence of a coin inserted through the coin slot 94 by a light-emitting portion and a light-receiving portion attached on the coin passage. Coins that have passed through the coin currency path in this manner are stored in the coin box.

The prize outlet 96 is disposed on the front surface of the base portion 80 and is for removing a prize that has fallen when the prize acquired by the acquisition unit 20 falls through the opening area in the display section 60.

The setting unit 100 is used when a player performs game operations or the like, or when a service provider performs setting operations. As illustrated in FIG. 1 and FIG. 2, the setting unit 100 in one or more embodiments has a setting operation unit 101 and a screen display 102.

The setting operation unit 101 is for receiving operation input. The setting operation unit 101 in one or more embodiments is constituted of a touch panel, and receives input instructions from the operator from the pressing position thereof.

The touch panel is layered on top of the screen display 102, and when a touch operation is performed on the screen, the pressed position (contact position) can be detected based on the change in electrostatic capacitance between the fingertip and the conductive film.

The screen display 102 displays various screens such as a game screen and a setting screen. The screen display 102 in one or more embodiments is constituted of a liquid crystal display.

The control unit 110 is disposed inside the base portion 80 and is a control unit for carrying out various controls of the prize acquisition game device 1. As illustrated in FIG. 2, the control unit 110 includes at least a central processing unit (CPU) 111 and a memory 112.

The CPU 111 is an arithmetic processing device for controlling the entire game device. The memory 112 is used to secure an area for storing programs or instructions for the CPU 111, a working area, and the like, and includes a storage element such as a random access memory (RAM).

The memory unit 120 is a unit that stores programs or instructions and data for the control unit 110 to execute game processing. In one or more embodiments, a memory element such as a read only memory (ROM) which is a read-only memory area is provided.

### Configuration of Acquisition Unit 20

### <Acquisition Unit 130 of Comparative Example>

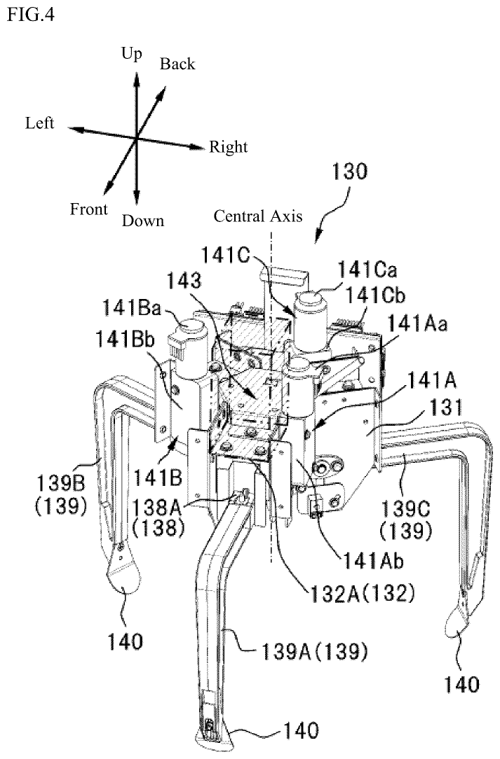

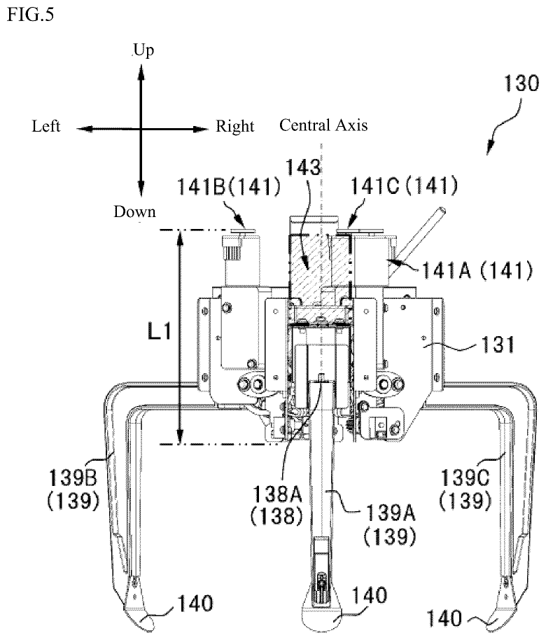

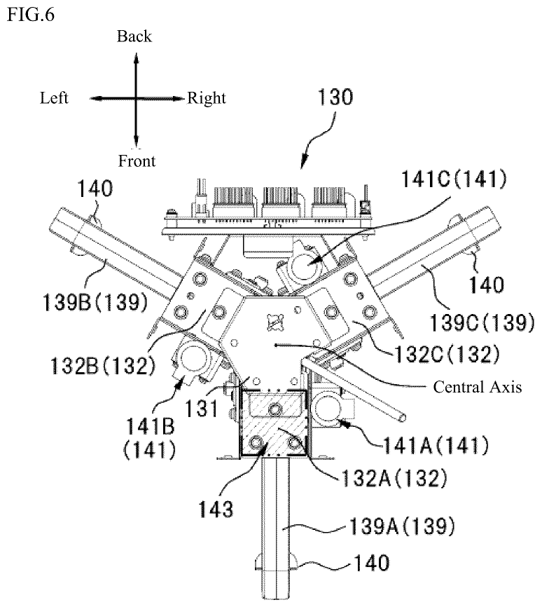

First, before describing the configuration of the acquisition unit 20 according to one or more embodiments, a configuration of a conventional acquisition unit (or crane) 130 will be described using FIG. 4 to FIG. 6 as comparative examples. FIG. 4 is a perspective view illustrating a configuration of the acquisition unit 130 of the comparative example. FIG. 5 is a front view illustrating a configuration of the acquisition unit 130 of the comparative example. FIG. 6 is a plan view illustrating a configuration of the acquisition unit 130 of the comparative example. Note that in each FIG., the acquisition unit 130 is illustrated having the design cover removed.

As illustrated in FIG. 4 to FIG. 6, the acquisition unit 130 of the comparative example includes a base portion (or base) 131 linkable to a lower end of the lifting member 52a, an arm 139 that performs an opening and closing operation, a claw 140 attached to a tip of the arm 139, an arm connector 138 that connects the arm 139 to the base portion 131 in a removable manner, and a arm driver 141 that opens and closes the arm 139.

The base portion 131 of the comparative example has protruding portions 132 that extend radially so as to have equal angle spacing around a center axis along a vertical direction. Specifically, as illustrated in FIG. 6, it is composed of a first protruding portion 132A, a second protruding portion 132B, and a third protruding portion 132C having a trifurcated protruding shape shifted at 120 degree intervals three ways, centered on the center axis of the base portion 131.

The arm 139 of the comparative example is composed of three arms: a first arm 139A, a second arm 139B, and a third arm 139C, and extends radially around the center axis of the base portion 131 at intervals of 120 degrees. That is, as illustrated in FIG. 6, a first arm 139A, a second arm 139B, and a third arm 139C are disposed corresponding to the first protruding portion 132A, the second protruding portion 132B, and the third protruding portion 132C.

The arm connector 138 of the comparative example is composed of three parts: a first arm connector 138A, a second arm connector 138B, and a third arm connector 138C, and is disposed for each arm. That is, the first arm connector 138A connects the first arm 139A to the first protruding portion 132A of the base portion 131 as illustrated in FIG. 4. Similarly, the second arm connector 138B connects the second arm 139B to the second protruding portion 132B of the base portion 131, and the third arm connector 138C connects the third arm 139C to the third protruding portion 132C of the base portion 131.

The arm driver 141 of the comparative example is composed of three parts, a first arm driver 141A, a second arm driver 141B, and a third arm driver 141C, one for each arm. As illustrated in FIG. 4 to FIG. 6, the first arm driver 141A, the second arm driver 141B, and the third arm driver 141C correspond to the first arm 139A, the second arm 139B, and the third arm 139C, respectively, and drive them to open and close separately.

As illustrated in FIG. 4, the first arm driver 141A has an arm opening and closing motor 141Aa, and a gearbox 141Ab linked to the arm opening and closing motor 141Aa. The first arm 139A performs the opening and closing operation by the power of the arm opening and closing motor 141Aa being transmitted via the gearbox 141Ab. Similarly, the second arm driver 141B has an arm opening and closing motor 141Ba and a gearbox 141Bb linked to the arm opening and closing motor 141Ba, and the third arm driver 141C has an arm opening and closing motor 141Ca and a gearbox 141Cb linked to the arm opening and closing motor 141Ca.

In the case of this comparative example, as illustrated in FIG. 4, the arm driver 141 (first arm driver 141A to third arm driver 141C) of the comparative example is disposed inside the acquisition unit 130 in a standing state along the up-down direction (vertical direction). Therefore, as illustrated in FIG. 5, an increase in the up-down thickness L1 (that is, the vertical height) may cause the entire acquisition unit 130 to become larger.

Furthermore, inside the acquisition unit 130 of the comparative example, the upper space of each arm connector 138 is respectively empty. For example, when looking at the first arm connector 138A, as illustrated in FIG. 4 to FIG. 6, the upper space 143 of the first arm connector 138A is an empty space (indicated by diagonal lines in the figure). Similarly, the upper space of the second arm connector 138B and the third arm connector 138C is empty. By forming a large number of such empty spaces inside the acquisition unit 130, there is a risk that the entire acquisition unit 130 will become larger.

### <Acquisition Unit 20 of One or More Embodiments>

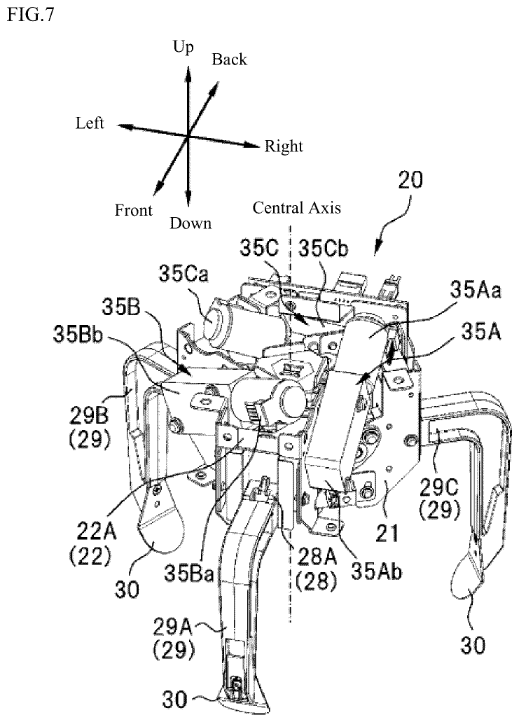

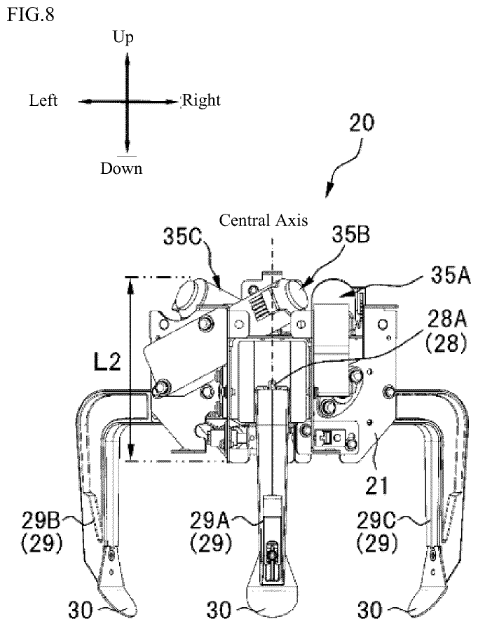

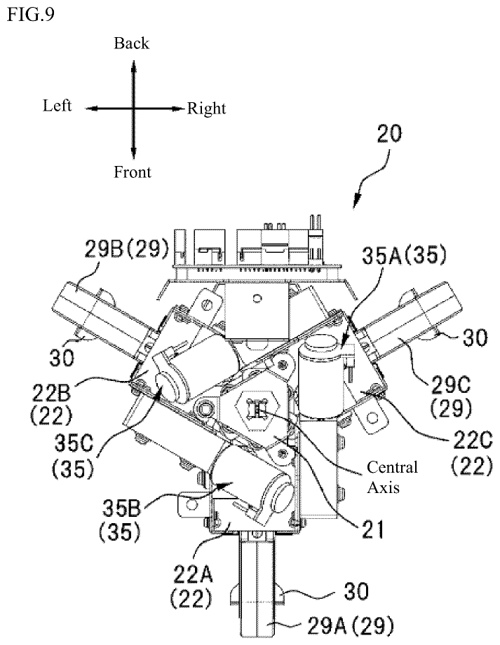

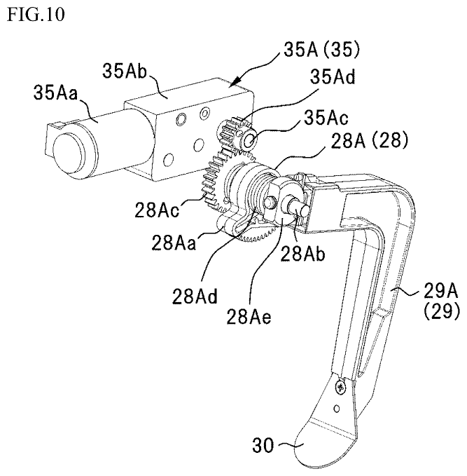

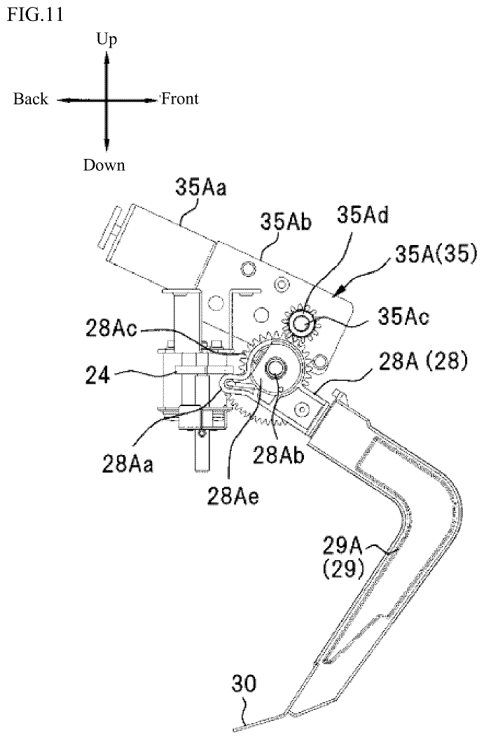

Configuration examples of the acquisition unit 20 according to one or more embodiments will be described using FIG. 7 to FIG. 11. FIG. 7 is a schematic diagram illustrating a configuration of an acquisition unit 20 according to one or more embodiments. FIG. 8 is a front view illustrating a configuration of an acquisition unit 20 according to one or more embodiments. FIG. 9 is a plan view illustrating a configuration of the acquisition unit 20 according to one or more embodiments. FIG. 10 is a schematic diagram for describing the relationship between the arm 29, the arm coupling portion 28, and the arm driver 35 according to one or more embodiments. FIG. 11 is a schematic view illustrating the arm 29 according to one or more embodiments in the closed position. Note that in each FIG., the acquisition unit 20 is illustrated having the design cover removed.

As illustrated in FIG. 7 to FIG. 9, similarly to the case of the above comparative example, the acquisition unit 20 according to one or more embodiments includes a base portion (or base) 21 linked to a lower end of the lifting member 52a, an arm 29 that performs an opening and closing operation, a claw 30 attached to a tip of the arm 29, an arm connector 28 that connects the arm 29 to the base portion 21 in a removable manner, and a arm driver 35 that opens and closes the arm 29.

The base portion 21 of the comparative example has protruding portions 22 that extend radially so as to have equal angle spacing around a center axis along a vertical direction. Specifically, as illustrated in FIG. 9, it is composed of a first protruding portion 22A, a second protruding portion 22B, and a third protruding portion 22C having a trifurcated protruding shape shifted at 120 degree intervals three ways, centered on the center axis of the base portion 21.

The arm 29 of the comparative example is composed of three arms: a first arm 29A, a second arm 29B, and a third arm 29C, and extends radially around the center axis of the base portion 21. Specifically, as illustrated in FIG. 9, the first arm 29A, the second arm 29B, and the third arm 29C are disposed corresponding to the first protruding portion 22A, the second protruding portion 22B, and the third protruding portion 22C, and each arm 29 extends radially so as to have an equiangular interval (120 degree interval) centered on the center axis of the base portion 21. As illustrated in FIG. 7, the arm 29 has a claw 30 attached to the tip thereof, and an arm connector 28 is connected to the base thereof.

The arm connector 28 of the comparative example is composed of three parts: a first arm connector 28A, a second arm connector 28B, and a third arm connector 28C, and is disposed for each arm. That is, the first arm connector 28A connects the first arm 29A to the first protruding portion 22A of the base portion 21 as illustrated in FIG. 7. Similarly, the second arm connector 28B connects the second arm 29B to the second protruding portion 22B of the base portion 21, and the third arm connector 28C connects the third arm 29C to the third protruding portion 22C of the base portion 21. Hereinafter, only the first arm connector 28A will be specifically described, and the rest will be omitted as all of the arm connectors 28 have the same configuration.

As illustrated in FIG. 10 and FIG. 11, the first arm connector 28A includes a protruding portion 28Aa, an arm shaft 28Ab that serves as a central axis when the first arm 29A rotates, a transmission gear 28Ac that rotates integrally with the arm shaft 28Ab, a torsion spring 28Ad as an example of an elastic body, and a fastening portion 28Ae.

As illustrated in FIG. 11, the protruding portion 28Aa is disposed at one end of the first arm connector 28A, and abuts the stopper 24 of the base portion 21 to limit the rotational operation of the first arm 29A in the closed direction.

The arm shaft 28Ab is inserted into an insertion hole that is not illustrated of the first arm connector 28A and attached to the base portion 21 through a passage hole that is not illustrated of the first protruding portion 22A. The transmission gear 28Ac is fitted so as to be integrated with the arm shaft 28Ab, and transmits power to the first arm 29A by driving the arm driver 35.

The torsion spring 28Ad applies a gripping force to the arm 29, and, as illustrated in FIG. 9, is attached to the arm shaft 28Ab by screwing the fastening portion 28Ae so as not to fall off. The first arm connector 28A is connected to the first arm 29A via the torsion spring 28Ad.

The arm driver 35 of the comparative example is composed of three parts, a first arm driver 35A, a second arm driver 35B, and a third arm driver 35C, one for each arm. As illustrated in FIG. 7 to FIG. 9, the first arm driver 35A, the second arm driver 35B, and the third arm driver 35C correspond to the first arm 29A, the second arm 29B, and the third arm 29C, respectively, and drive them to open and close separately. Hereinafter, only the first arm driver 35A will be specifically described, and the rest will be omitted as all of the arm drivers 35 have the same configuration.

As illustrated in FIG. 10 and FIG. 11, the first arm driver 35A has an arm opening and closing motor 35Aa, a gearbox 35Ab linked to the arm opening and closing motor 35Aa, an output shaft 35Ac of the gearbox 35Ab, and a transmission gear 35Ad attached to the output shaft 35Ac.

The gearbox 35Ab reduces the rotational force of the arm opening and closing motor 35Aa and outputs it. Note that the transmission gear 35Ad may be directly attached to the output shaft of the arm opening and closing motor 35Aa (not illustrated) without going through the gearbox 35Ab.

When the transmission gear 35Ad is rotated via the gearbox 35Ab by the drive of the arm opening and closing motor 35Aa, power is transferred to the transmission gear 28Ac that engages the transmission gear 35Ad. As a result, the first arm 29A connected to the first arm connector 28A via the torsion spring 28Ad rotates around the arm shaft 28Ab.

In the case of the acquisition unit 20 according to one or more embodiments, unlike the case in the comparative example, when two adjacent arms 29 from among the three arms 29 are captured as one set, as illustrated in FIG. 7 or FIG. 9, the arm driver 35 for opening and closing the other arms 29 is disposed in the upper space of the arm connector 28 that connects one arm 29 from among the two arms 29 to the base portion 21 in both sets. This arrangement is achieved by attaching the arm driver 35 that drives the other arms 29 to the base portion 21 by tilting them toward one arm 29. That is, as illustrated in FIG. 9, each arm driver 35 is disposed in a shape of a ring around the center axis of the acquisition unit 20.

Specifically, as illustrated in FIG. 7 or FIG. 9, the second arm driver 35B corresponding to the second arm 29B is disposed in the upper space of the first arm connector 28A corresponding to the first arm 29A. Here, this arrangement is achieved by rotating the second arm driver 35B corresponding to the second arm 29B around the output shaft 35Bc of the second arm driver 35B and tilting the base portion 21 toward the first arm 29A.

Then, as illustrated in FIG. 7 or FIG. 9, the third arm driver 35C corresponding to the third arm 29C is disposed in the upper space of the second arm connector 28B corresponding to the second arm 29B. Here, this arrangement is achieved by rotating the third arm driver 35C corresponding to the third arm 29C around the output shaft 35Cc of the third arm driver 35C and tilting the base portion 21 toward the second arm 29B.

Furthermore, as illustrated in FIG. 7 or FIG. 9, the first arm driver 35A corresponding to the first arm 29A is disposed in the upper space of the third arm connector 28C corresponding to the third arm 29C. Here, this arrangement is achieved by (see FIG. 11) rotating the first arm driver 35A corresponding to the first arm 29A around the output shaft 35Ac of the first arm driver 35A and tilting the base portion 21 toward the third arm 29C.

In other words, as illustrated in FIG. 9, each arm driver (first arm driver 35A to third arm driver 35C) is disposed in a trifurcated shape around the center axis of the acquisition unit 20 inside the acquisition unit 20.

In this manner, in one or more embodiments, the arm driver 35 (first arm driver 35A to third arm driver 35C) is disposed inside the acquisition unit 20 in a state that is tilted with respect to the up-down direction (vertical direction). Therefore, as illustrated in FIG. 8, the thickness L2 in the up-down direction (that is, the height in the vertical direction) can be made thinner than the thickness L1 in the comparative example described above (see FIG. 5). In other words, because the height of the arm driver 35 can be disposed while being kept low in the vertical direction, the entire acquisition unit 20 can be made smaller by storing the arm driver 35 compactly inside the body. Furthermore, by making the acquisition unit 20 thinner, the amount of movement in the vertical direction within the housing space of the acquisition unit 20 can be increased compared to the comparative example.

Furthermore, in the comparative example described above, the upper space of each arm connector 138 is respectively empty inside the acquisition unit 130, but in one or more embodiments, the upper space of each arm connector 28 is effectively utilized inside the acquisition unit 20. Thus, by reducing wasted space inside the body, the arm driver 35 corresponding to each arm 29 can be stored compactly inside the body, and thus the entire acquisition unit 20 can be made smaller.

### OTHER EMBODIMENTS

The above embodiments are provided to facilitate understanding of the present invention, and are not to be construed as limiting the present invention. The present invention can be modified or improved without departing from the spirit thereof, and the present invention also includes equivalents thereof. In particular, the embodiments described below are also included in the present invention. In other words, the present invention can be configured by appropriately combining the above embodiments with the embodiments described below.

Furthermore, it is also possible to construct various inventions by appropriately combining multiple invention-defining matters disclosed in the above embodiments. For example, the invention may be constructed by deleting some of the invention-defining matters from all of the invention-defining matters disclosed in the above embodiments, or the invention may be constructed by appropriately combining all of the invention-defining matters disclosed in the above embodiments with the invention-defining matters disclosed in the embodiments described below.

### Prizes

In the above embodiments, the prizes stored in the housing portion 10 are not limited to items that the player can directly acquire (for example, stuffed toys or the like), but also include items that are stored as targets for acquisition in the game and can be exchanged for other prizes after acquisition, and items that are not provided themselves but are used to compete for points or rankings.

### Arm

In the above embodiments, the acquisition unit 20 having three arms 29 has been described as an example, but the present invention is not limited to this. For example, the present invention can also be applied to an acquisition unit 20 having four or more arms 29. In this case, as the number of arms 29 increases, the number of arm connectors 28, arm drivers 35, protruding portions 22 of the base portion 21, and the like can be increased.

### Arm Driver

In the above embodiments, a case where a motor is used as an example of a rotating driving unit 35 is described, but the present invention is not limited thereto. For example, the present invention can also be applied to a linear arm driver 35 such as a solenoid.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### DESCRIPTION OF REFERENCE NUMERALS

1 Prize acquisition game device
10 Housing portion
11 Opening and closing door
20 Acquisition unit
21 Base portion
22 Protruding portion
22A First protruding portion
22B Second protruding portion
22C Third protruding portion
24 Stopper
28 Arm connector
28A First arm connector
28Aa Protruding portion
28Ab Arm shaft
28Ac Transmission gear
28Ad Torsion spring
28Ae Fastening portion
28B Second arm connector
28C Third arm connector
29 Arm
29A First arm
29B Second arm
29C Third arm
30 Claw
35 Arm driver
35A First arm driver
35Aa Arm opening and closing motor
35Ab Gearbox
35Ac Output shaft
35Ad Transmission gear
35B Second arm driver
35Ba Arm opening and closing motor
35Bb Gearbox
35Bc Output shaft
35Bd Transmission gear
35C Third arm driver
35Ca Arm opening and closing motor
35Cb Gearbox
35Cc Output shaft
35Cd Transmission gear
50 Moving unit
51 Horizontal moving portion
52 Vertical moving portion
52a Lifting member
53 Left-right moving portion
53a Fixed rail
53b Left-right moving motor
54 Front-back moving portion
54a Movable rail
54b Front-back moving motor
60 Display section
80 Base portion
90 Operation unit
91 Joystick
92 Operation button
93 Play fee detector
94 Coin slot
96 Prize outlet
100 Setting unit
101 Setting operation unit
102 Screen display
110 Control unit
111 CPU
112 Memory
120 Memory unit
130 Acquisition unit
131 Base portion
132 Protruding portion
132A First protruding portion
132B Second protruding portion
132C Third protruding portion
138 Arm connector
138A First arm connector
138B Second arm connector
138C Third arm connector
139 Arm
139A First arm
139B Second arm
139C third arm
140 Claw
141 Arm driver
141A First arm driver
141Aa Arm opening and closing motor
141Ab Gearbox
141B Second arm driver
141Ba Arm opening and closing motor
141Bb Gearbox
141C Third arm driver
141Ca Arm opening and closing motor
141Cb Gearbox
143 Upper space

What is claimed is:

1. A prize acquisition game device, comprising:
a housing having a housing space in which a prize is disposed;
a crane configured to acquire the prize; and
a crane driver that drives the crane to move in a horizontal and vertical direction in the housing space, wherein
the crane comprises:
a base;
at least three arms that extend radially around a center axis along a vertical direction of the base;
an arm connector that is disposed for each of the arms and connects each of the arms to the base; and
arm drivers that are disposed respectively for the arms around the center axis and drive the arms to be opened and closed, wherein
among the arm drivers, an arm driver that drives one of two adjacent arms is disposed to extend above the arm connector that connects another of the two adjacent arms to the base.

2. The prize acquisition game device according to claim 1, wherein,
by mounting the arm driver that drives the one of the two adjacent arms to the base by tilting the arm driver that drives the one of the two adjacent arms to a side of the other of the two adjacent arms, the arm driver that drives the one of the two adjacent arms is disposed to extend above the arm connector that connects the other of the two adjacent arms to the base.

3. A prize acquisition game device, comprising:
a housing having a housing space in which a prize is disposed;
a crane configured to acquire the prize; and
a crane driver that drives the crane to move in a horizontal and vertical direction in the housing space, wherein
the crane comprises:
a base;
three arms that extend radially around a center axis along a vertical direction of the base;
an arm connector that is disposed for each of the arms and connects each of the arms to the base; and
arm drivers that are disposed respectively for the arms around the center axis and drive the arms to be opened and closed, wherein
the arms include a first arm, a second arm, and a third arm, and
the arm drivers include:
a first arm driver that drives the second arm and is disposed to extend above the arm connector that connects the first arm to the base;
a second arm driver that drives the third arm and is disposed to extend above the arm connector that connects the second arm to the base; and
a third arm driver that drives the first arm and is disposed to extend above the arm connector that connects the third arm to the base.

4. The prize acquisition game device according to claim 3, wherein
the first arm driver is disposed to extend above the arm connector that connects the first arm to the base by tilting the first arm driver to a side of the first arm when attaching the first arm driver to the base,
the second arm driver is disposed to extend above the arm connector that connects the second arm to the base by tilting the second arm driver to a side of the second arm when attaching the second arm driver to the base, and
the third arm driver is disposed to extend above the arm connector that connects the third arm to the base by tilting the third arm driver to a side of the third arm when attaching the third arm driver to the base.

5. A crane used in a prize acquisition game device to perform a prize acquisition operation, the crane comprising:
a base;
at least three arms that extend radially around a center axis along a vertical direction of the base;
an arm connector that is disposed for each of the arms and connects each of the arms to the base; and
arm drivers that are disposed respectively for the arms around the center axis and drive the arms to be opened and closed, wherein
among the arm drivers, an arm driver that drives one of two adjacent arms is disposed to extend above the arm connector that connects another of the two adjacent arms to the base.

6. A crane used in a prize acquisition game device, the crane comprising:
a base;
three arms that extend radially around a center axis along a vertical direction of the base;
an arm connector that is disposed for each of the arms and connects each of the arms to the base; and
arm drivers that are disposed respectively for the arms around the center axis and drive the arms to be opened and closed, wherein
the arms include a first arm, a second arm, and a third arm, and
the arm drivers include:
a first arm driver that drives the second arm and is disposed to extend above the arm connector that connects the first arm to the base;
a second arm driver that drives the third arm and is disposed to extend above the arm connector that connects the second arm to the base; and
a third arm driver that drives the first arm and is disposed to extend above the arm connector that connects the third arm to the base.
